(19) United States
(12) Patent Application Publication
(10) Pub. No.: US 2021/0103804 A1
(43) Pub. Date: Apr. 8, 2021

(54) Neuron-Based Computational Machine

(71) Applicant: General Radar Corporation, Menlo Park, CA (US)

(72) Inventor: Dmitry Turbiner, Menlo Park, CA (US)

(21) Appl. No.: 16/744,020

(22) Filed: Jan. 15, 2020

Related U.S. Application Data
(60) Provisional application No. 62/927,985, filed on Oct. 30, 2019.
(60) Provisional application No. 62/909,708, filed on Oct. 2, 2019.

(51) Int. Cl. G06N 3/063; G06F 17/15; G06F 17/14; G06F 9/30

(52) U.S. Cl. CPC G06N 3/063; G06F 9/30134; G06F 17/142; G06F 17/15

(57) ABSTRACT

A computation machine comprises a first data buffer, a second data buffer, a correlator neuron and a neuron controller. The first data buffer stores a multi-bit input data value. The second data buffer stores a multi-bit weight value. The correlator neuron includes multiple single-bit digital dendrites, each of which inputs, at a point in time, one bit of the input data value from the first data buffer and one bit of the weight value from the second data buffer. The correlator neuron generates an output indicative of a correlation between the buffered input data value and the buffered weight value. The neuron controller provides the weight value to the correlator neuron circuit, and controls one or both of the first data buffer and the second data buffer to cause a shifting, relative to each other, of the input data value and the weight value.

This application claims the benefit of U.S. provisional patent application No. 62/909,708, filed on Oct. 2, 2019, and U.S. provisional patent application No. 62/927,985, filed on Oct. 30, 2019, each of which is incorporated by reference herein in its entirety.

### BACKGROUND

Correlation is a mathematical function used in many computer-implemented applications. In certain applications, such as “big data,” radar and communications, the maximum computational throughput of the correlation function may be a key factor in the performance of the overall system. With conventional technology, constraints on how the correlation function is implemented, physically and/or logically, significantly limit the computational throughput of the correlation function and thereby limit the performance of the overall system.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates a correlator neuron.

FIG. 2 is a block diagram illustrating an example of a correlator neuron-based computational machine that includes the correlator neuron of FIG. 1.

FIG. 3 illustrates an example of a correlator neuron-based computational machine for use in “big data” applications.

FIG. 4 illustrates an example of a correlator neuron-based computational machine for use in object detection/ranging or communications applications.

FIG. 5 is a flow diagram illustrating an example of an overall process that can be performed by a correlator neuron-based computational machine.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

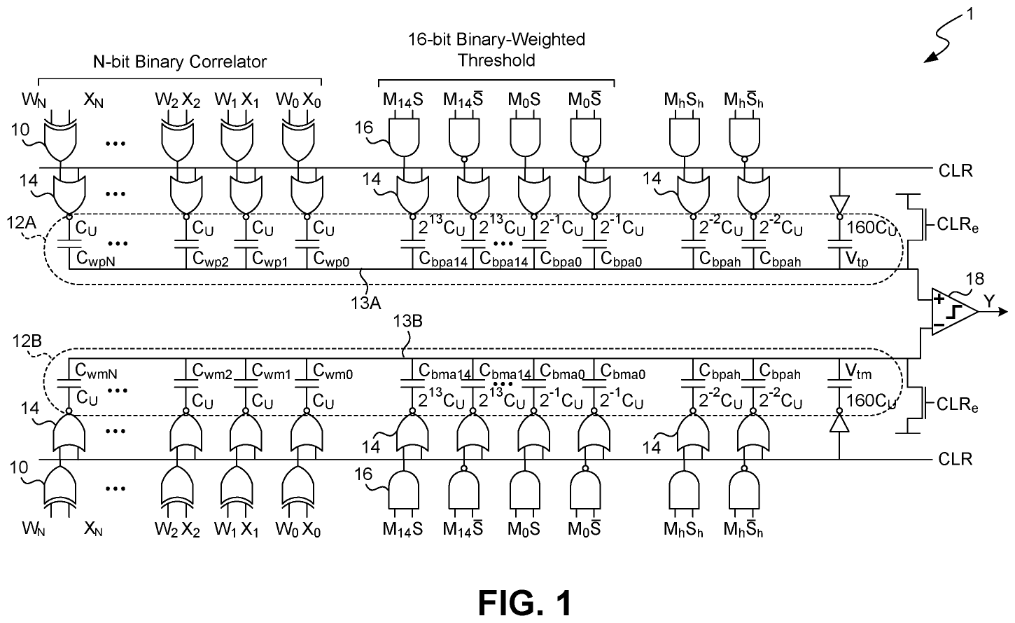

The technology described herein includes a new class of computational machine. In at least some embodiments the computational machine includes two main building blocks: a correlator neuron circuit and a neuron controller circuit. An example of a correlator neuron circuit (hereinafter simply “correlator neuron”) is illustrated in FIG. 1. The primary purpose of the correlator neuron is to compute the mathematical formula of vector algebra, Y=Convolution(X, W), where X is the input vector, Y is the output and W is the vector of weights.

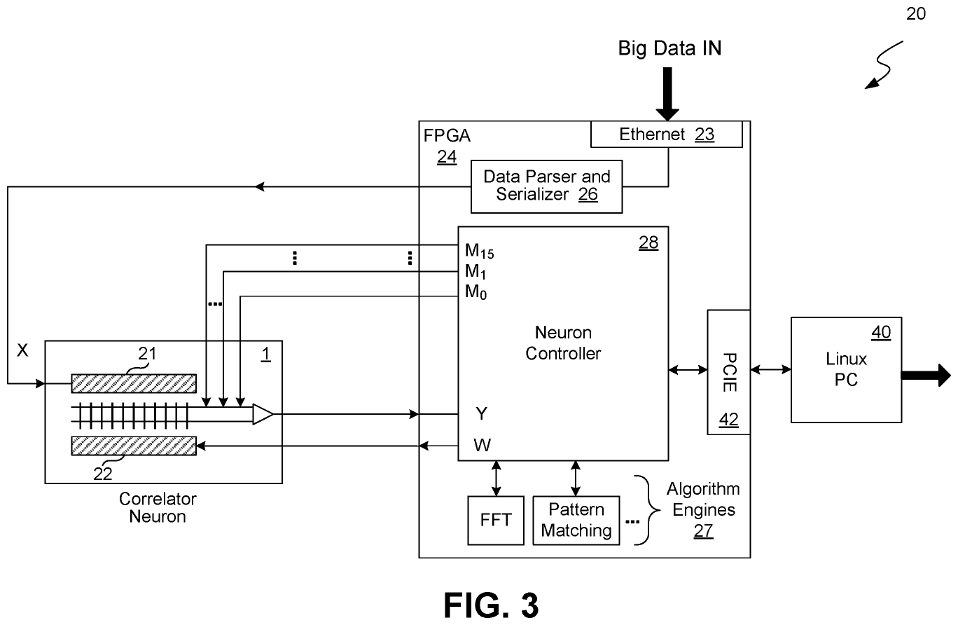

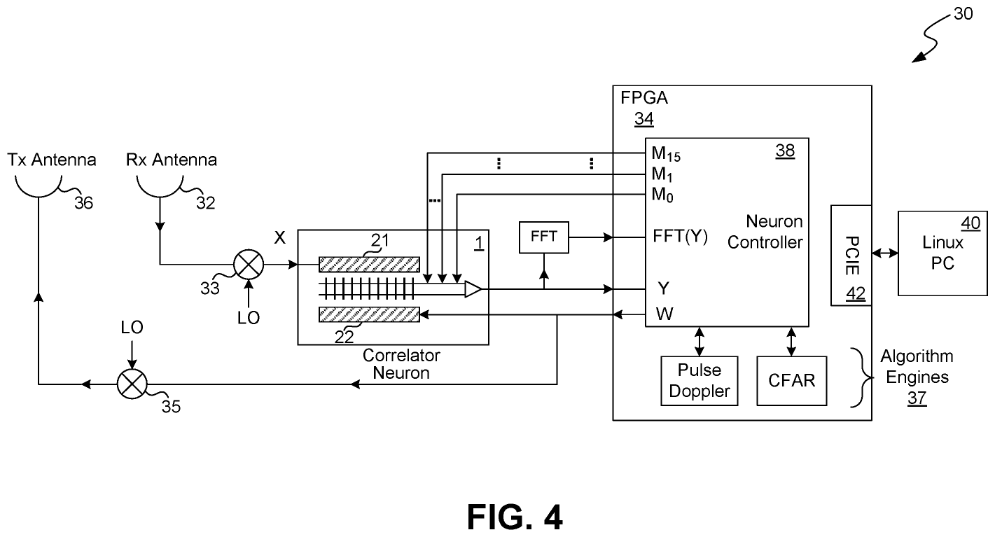

The primary purpose of the neuron controller circuit (hereinafter simply “neuron controller”) is to bring data into and out of the correlator neuron and pipe it to appropriate algorithm engines (i.e., circuitry, also called computational engines), such as a Fast Fourier Transform (FFT) engine, Pattern Recognition engine, etc., as well as to enable user control of the correlator neuron's input parameters. Examples of a neuron controller circuit as used in conjunction with the correlator neuron are illustrated in each of FIGS. 3 and 4.

A significant advantage of the computational machine introduced here is its very high computational throughput as compared to conventional correlation computing devices. For example, in at least one embodiment, the correlator neuron has more than 100,000 taps and, when clocked at 10 GHz, has a computational throughput of more than one peta-MAC (Multiply Accumulate) per Second or over two peta-OPS (Operations Per Second). Another advantage is the fact that the correlator neuron can fit on a single chip, such as a TSMC-28 chip. Furthermore, unlike conventional digital binary correlators, the correlator neuron described herein can be laid out on chip in a very long line and therefore can have a much higher number of taps than conventional binary correlators (which are commonly implemented using a generally triangular digital adder tree, thereby effectively requiring a generally square area on-chip). These attributes make the computational machine a peta-scale computer on a chip.

At least two examples of the computational machine, for two different applications, are described herein in detail. The first example is suitable for the processing of “big data.” Big data can be defined as extremely large data sets that may be analyzed computationally to reveal patterns, trends, and associations, especially (though not only) relating to human behavior and interactions. Big data can include, for example, DNA sequences, stock ticker data, etc. The primary function of this embodiment of the computational machine is to search for correlations in big data input sequences.

The second example described herein is suitable for wireless communications and/or object detection/ranging, such as radar, e.g., to detect a specific pattern in a received communications signal. Note that the computational machine introduced here can also be used advantageously for many other applications. For example, it can potentially be used for any other wave-based object detection/ranging technique, such as LIDAR or sonar, and/or for medical imaging applications such as ultrasound, magnetic resonance imaging (MRI), computerized tomography (CT), nuclear medicine tomography, and many other applications. In contrast with Surface-Acoustic-Wave correlators, the computational machine as applied in this manner is active and has no insertion loss. Furthermore, the circuit and resulting waveforms are fully reconfigurable/reprogrammable.

Before further discussing specific applications, the correlator neuron will now be described in further detail. In the embodiment illustrated in FIG. 1, the correlator neuron 1 includes a set of N multipliers whose outputs are tied through a corresponding set of capacitors to a summing junction (also called “summator”), e.g., a wire, which represents a synapse of the correlator neuron. Each multiplier is implemented as an XOR gate 10 that performs the “multiply” portion of a multiply-accumulate (MAC) operation and performs a comparison between an input bit, Xi, of the multi-bit input value, X, and a corresponding weight bit, Wi, of the multi-bit weight value, W. If there is a match, the XOR gate outputs (“fires”) a positive output pulse (logic 1). If there is not a match is wrong, the XOR gate fires a negative output pulse (logic 0). Hence, each XOR gate 10 can be considered a dendrite of the correlator neuron 1.

The “add” portion of the MAC operation is accomplished by a pair of summators 12A and 12B, each of which is coupled to the outputs of all of the dendrites. In at least one embodiment, as shown in FIG. 1, each summator 12A or 12B performs a digital-to-analog conversion and is implemented as a summing wire 13A or 13B and set of capacitors coupled between the summing wire and respective outputs of the dendrites. In other embodiments, the summators 12A and 12B can be digital summators.

In at least one embodiment, the XOR gates 10 are laid out in parallel, along the length of a relatively long, fat piece of wire (e.g., having an aspect ratio of approximately 1000:1). In at least one embodiment, when implemented on a chip of reasonable size using a 28 nm process, there are 131,072 such XOR gates (i.e., N=131,072), thereby providing the correlator neuron with 131,072 taps. Each XOR gate's output is coupled to the summing wire 13A or 13B through a separate capacitor Cwpi or Cwmi, each of which has a unit capacitance value, Cu. Hence, each input bit Xi is separately applied to a pair of equal-valued capacitors, Cwpi and Cwmi. The other terminal of each Cwpi capacitor is coupled to summing wire 13A, which is coupled to the positive input of a comparator 18 (e.g., an operational amplifier). The other terminal of each Cwmi capacitor is coupled to summing wire 13B, which is coupled to the negative input of the comparator 18.

For every XOR gate 10, if the inputs match, the XOR gate 10 “injects” a packet of charge Qu into its output summing wire 13A or 13B. If the inputs do not match, it “subtracts” a packet of charge Qu from the summing wire. Therefore, for a perfectly decorrelated X and W (e.g., perfect noise on the antenna input in the communications application), about half of the X's will match and about half will not match, producing an average charge of about zero on the summing wire 13A or 13B. For a perfect match between X and W (e.g., a strong radar reflector), every one of the XOR gates 10 will output (“fire”) positive. Therefore, in essence, Correlation(X, W)=Total charge on the summing wire.

In at least one embodiment, as shown in FIG. 1, the correlator neuron 1 also inputs a 16-bit binary weighted activation threshold value, M. Each bit Mi of the threshold value M is applied to one input of a separate two-input AND gate 14. Each AND gate 14 provides its output to one input of a separate XOR gate 14. Capacitors of different weight (capacitance) values (213 Cu down to 2-2 Cu in the illustrated embodiment) are each coupled to serially receive respective bits of the threshold M, to form a binary-to-charge converter. Hence, each threshold bit Mi is separately applied to a pair of equal-valued capacitors, Cbpai and Cbmai. The binary word representing the threshold is loaded onto the M inputs. For example, if one wants to apply a threshold of 255 Cu, one would load the number 0000 0000 0000 ff00. This action injects a packet of charge equal to 255 Cu into the summing wire 13A and 13B, thereby creating the equivalent of a threshold set at 255 Cu.

In at least one embodiment, as shown in FIG. 1, the output of each XOR gate 10 is passed through a separate two-input NOR gate 14 before being provided to the corresponding capacitor. The other input of each such NOR gate 14 receives a CLR input, which can be used to discharge all of the capacitors to clear the charge on the summing wires 13A and 13B. The Strobe input, S, is applied to the other input of each AND gate 16. Strobe input S (and complement thereof) regularly flushes out accumulated offsets in the binary-to-charge converter portion. In at least some embodiments, the strobe input S is activated approximately every one-hundredth clock cycle and does not have an impact on the computational bandwidth of the correlator neuron 1.

The Y output of the correlator neuron 1 is generated by a comparator 18, which in at least one embodiment is an analog-input comparator (e.g., an operational amplifier) that generates a one-bit binary output. The purpose of the comparator is to decide whether the charge on the summing wire is greater than or less than the charge on the summing wire from the 16-bit binary weighted activation threshold. Note that the comparator could instead be, for example, a flash analog-to-digital converter (ADC), such as a 3-bit or 5-bit flash ADC. In that case, the output of the correlator neuron may be, for example, a 3-bit or 5-bit value, instead of just one bit.

In at least some embodiments, such as illustrated in FIG. 1, the correlator neuron 1 has 131,072 taps and has its inputs clocked at a frequency of 10 GHz (i.e., the clock rate of a conventional serializer-deserializer (SERDES)). With the illustrated architecture, this can produce a computational throughput of 1.3 Peta-MACs per second or 2.6 operations per second (OPS). With the same number of taps and chip size, if the process technology is 7 nm and used with a 28 GHz SERDES, for example, the computational throughput can be 3.7 Peta-MACs per second or 7.4 OPS. The purpose of the series-coupled inverter and 160Cu capacitor Vₜₚ or Vₜₘ is to inject a constant voltage threshold to offset the input comparator bias voltage.

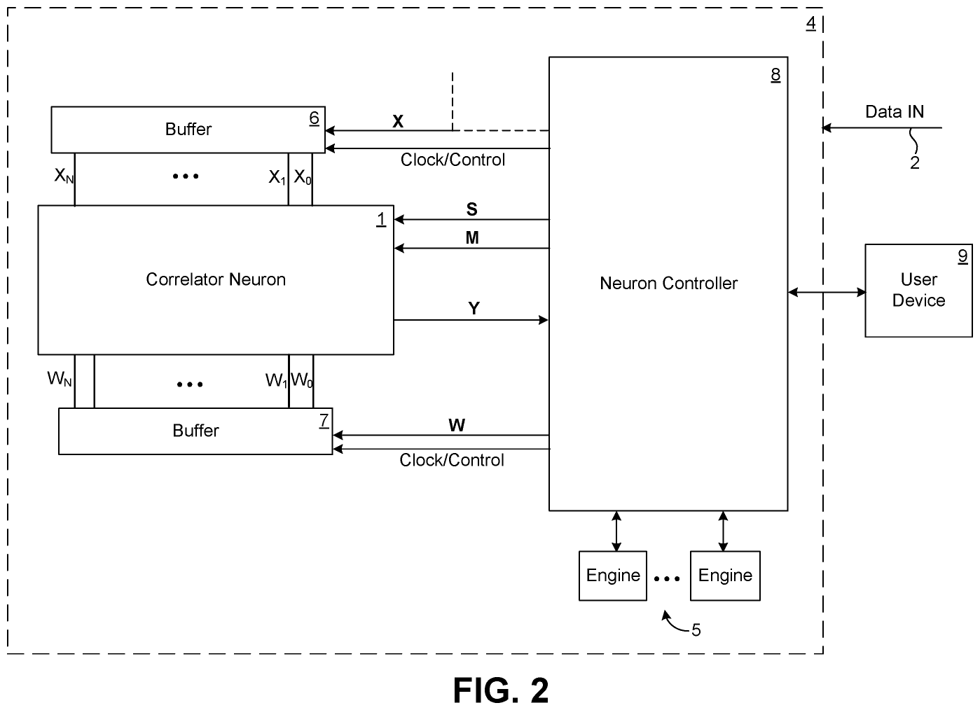

FIG. 2 illustrates how the correlator neuron 1 can be used in a correlation processing machine, and in particular, in a computational machine 4 such as mentioned above. As shown, the computational machine 4 includes, in addition to the correlator neuron 1, one or more algorithm engines 5, a first (N-bit) buffer 6, a second (N-bit) buffer 7 and a neuron controller 8. As noted above, in certain embodiments, N equals 131,072. The computational machine 4 receives, from an external source, an input data stream 2 from which the X inputs to the correlator neuron 1 are obtained. The input data 2 may be, but is not necessarily, routed first through the neuron controller 8 for pre-processing (e.g., parsing and/or serializing), depending on the application for which the computational machine 4 is configured. Further, the input data 2 can be pre-processed by one or more other components (not shown) within the computational machine 4. After any necessary pre-pre-processing, the X inputs are provided to the correlator neuron 1 via the first buffer 6. The W inputs are provided to the correlator neuron 1 via the second buffer 7. All N bit positions of each of the first buffer 6 and the second buffer 7 are output in parallel to the correlator neuron 1. The first buffer 6 and second buffer 7 are individually or collectively controllable by the neuron controller 8 to cause the X bits and W bits to be shifted relative to each other, so that each X bit gets applied as input at least once with each W bit to any given XOR gate 10 in the correlator neuron 1 (see FIG. 1). At least the first buffer 6 (for the X inputs) can be a shift register. The second buffer 7 (for the W inputs) may also be a shift register, or it may be a simple parallel load-and-hold register. Buffers 6 and 7 can be implemented on the same chip as the correlator neuron 1 and can be clocked at the clock rate of the SERDES (not shown). One or both of these buffers may be included within the correlator neuron 1 itself, or may be external to it as shown in FIG. 2.

The neuron controller 8 can be implemented in the form of any known or convenient type of logic circuitry, such as a field programmable gate array (FPGA), application-specific integrated circuit (ASIC), programmable microprocessor, etc. The neuron controller 8 clocks and/or otherwise controls the loading of the X and W input data into buffers 6 and 7, respectively, to cause the shifting of the X and W bit positions relative to each other. The neuron controller 8 also provides the threshold M and Strobe S inputs to the correlator neuron 1. Additionally, the neuron controller 8 receives the output Y values of the correlator neuron 1 and pipes those values into one or more algorithm engines 5, respectively, the details of which depend on the application for which the computational machine 4 is being used, such as logic for Fast Fourier Transform (FFT) and/or pattern recognition and tracking decision networks in a big data embodiment, or Pulse Doppler and Constant False-Alarm Rate (CFAR) in a radar/communications embodiment. The outputting of result data and high-level control of the computational machine 4 (e.g., selection of input data stream, and setting of threshold M and weight W values) can be done on, or controlled from, user device 9, which can be, for example, a Linux based personal computer (PC) or any other known or convenient type of end-user processing device, such as a smartphone, tablet computer, or the like.

The computational machine 4 can be used in various practical applications, as will now be further described. FIG. 3 illustrates an embodiment of a computational machine 20 which includes the correlator neuron 1, for processing big data. FIG. 4 illustrates an embodiment of a computational machine 30 which includes the correlator neuron 1, for processing radar signals or other communication signals. In general, the X inputs are provided to the correlator neuron 1 via a first buffer, and all the W inputs are provided to the correlator neuron 1 via a second buffer, where the first and second buffers are controllable so that the X bits and W bits can be shifted relative to each other, so that each X bit gets applied as input at least once with each W bit to any given XOR gate 10. At least the first buffer (for X inputs) can be a shift register, whereas the W register may be a shift register or a simple parallel load-and-hold register. The first and second buffers can be implemented on the same chip as the correlator neuron 1 and can be clocked at the clock rate of the SERDES. One or both of these buffers may be included within the correlator neuron 1 itself, or external to it.

In the illustrated embodiments, the X inputs are provided to the correlator neuron 1 via a first shift register 21, and all the W inputs are provided to the correlator neuron 1 via a second shift register 22. The shift registers 21 and 22 can be implemented on the same chip as the correlator neuron 1 and can be clocked at the clock rate of the SERDES. One or both of the shift registers 21 and 22 may be included within the correlator neuron 1 itself, or external to it. Each of these shift registers 21 and 22 outputs its contents in parallel to the corresponding X or W inputs of the correlator neuron 1.

The most significant difference between these two embodiments is what the X input of the correlator neuron 1 gets connected to. In the big data embodiment (FIG. 3), X is controlled from within the FPGA 24 that implements the correlator neuron 1. A sequence of big data comes into the FPGA 34 through, for example, an Ethernet interface 23, such as a 100 Gbps Ethernet interface. The data stream gets parsed and serialized into a binary stream representing the X inputs by a data parser and serializer (SERDES) 26. This binary stream gets piped into the correlator neuron's X shift register 21. The computational machine 30 then performs Correlation(X,W) on the data, which may be, for example, DNA data, or high-frequency stock ticker data. The architecture of the computational machine 20 enables this computation to be done at a rate on the order of multiple peta-operations per second (OPS).

The radar/communications embodiment (FIG. 4) is similar to the big data embodiment, except that the X input of the correlator neuron 1 is connected to the output of a receive antenna 32, or more generally, to the output of a sensor or a signal representative of the output of a sensor. Specifically, in the illustrated embodiment the receive antenna 32 signal is mixed by mixer 33 with the output of a local oscillator (LO), the output of which is then piped into the X shift register 21 of the correlator neuron 1. This can be done at a clock rate of, for example, 10 GHz. The W shift register 22 is loaded serially from the neuron controller 38 (discussed further below) with the desired pattern to be recovered, and is also input to a mixer 35, which mixes the W stream with the output of a local oscillator (LO), the output of which is then applied to the transmit antenna 36. In this embodiment, the X shift register 21 may be clocked at, for example, 10 GHz, while the W shift register 22 is clocked at 1 MHz.

The computational machine 30 according to this embodiment can achieve 50 dB of correlation gain at 10 GSPS for radar applications, yielding radar ranges on the order of 100 miles. In an example of a non-radar communications application, the input X taps can receive, for example, long PRN sequences, such as for CDMA based communication systems.

At least in the case of the big data embodiment (FIG. 3), the correlator neuron 1 can receive the input X data to be correlated via a Field Programmable Gare Array (FPGA) 24, and more specifically, from a SERDES 26 on the FPGA 24, which parses the input data into serial binary form. In at least one embodiment, 18 10-Gbps SERDES on the FPGA 24 are used to interface with the correlator neuron: 16 SERDES are used for the threshold; one SERDES is used to load (and hold) the W (weight) values into the shift register, and one SERDES is used to receive the correlator neuron's comparator output. Of course, other configurations are possible.

Although the X and W shift registers 21 and 22, respectively, can be clocked at the same rate, that is not necessarily the case, and in fact may not be desirable in certain applications. For example, in at least some applications and embodiments, the W shift register may be clocked (shifted) at a much slower rate than the X shift register. For example, in a radar application, the W shift register 22 may be clocked at 1 MHz while the X register 21 is clocked at 10 GHz (in effect, the W value is essentially stationary relative to the much faster shifting stream of X bits).

The FPGA 24 or 34 also contains a neuron controller 28 or 38, which adjusts the correlator neuron's threshold M and weight W values (e.g., in response to user inputs). The neuron controller 28 or 38 also receives the output Y values of the correlator neuron and pipes them into one or more algorithm engines 27or 37, respectively, the details of which depend on the application, such as algorithm engines for Fast Fourier Transform (FFT) and/or pattern recognition and tracking decision networks in a big data embodiment, or Pulse Doppler and Constant False-Alarm Rate (CFAR) in a radar/communications embodiment. The outputting of result data and high-level control of the computational machine 20 or 30 (e.g., selection of input data stream, and setting of threshold M and weight W values) can be done by a Linux based personal computer (PC) 40 via, for example, a PCI-express (PCIe) interface 42 on the FPGA, in response to user inputs.

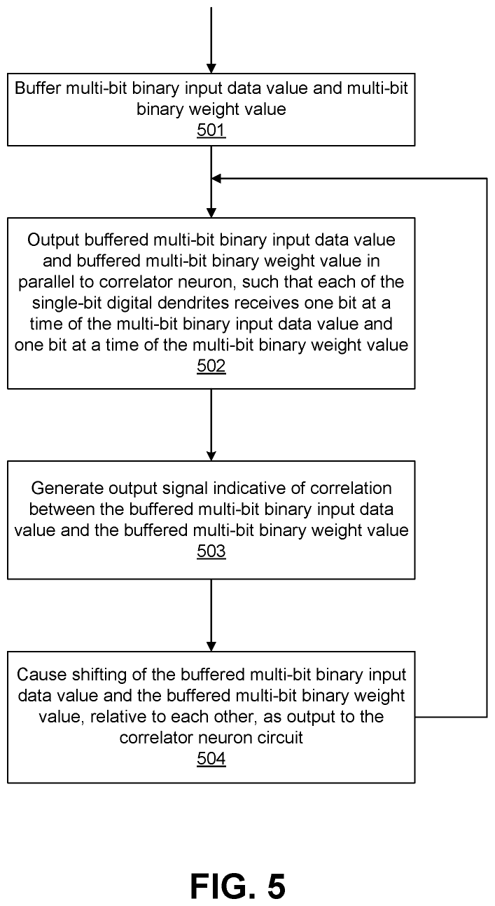

FIG. 5 is a flow diagram illustrating an example of a process that can be performed by computational machines 4, 40 or 40. At step 501, the computational machine buffers a multi-bit binary input data value and a multi-bit binary weight value. At step 501 the computational machine outputs the buffered multi-bit binary input data value and the buffered multi-bit binary weight value in parallel to a correlator neuron, such as correlator neuron 1 in FIGS. 1 through 4. As described above, the correlator neuron includes a plurality of single-bit digital dendrites. This outputting step 501 is done such that each of the single-bit digital dendrites in the correlator neuron 1 receives one bit at a time of the multi-bit binary input data value and one bit at a time of the multi-bit binary weight value. At step 503 the computational machine (or the correlator neuron within it) generates an output signal indicative of correlation between the buffered multi-bit binary input data value and the buffered multi-bit binary weight value. At step 504 the neuron controller causes a shifting of the buffered multi-bit binary input data value and the buffered multi-bit binary weight value, relative to each other, as output to the correlator neuron circuit. The process then loops back to step 502, and may continue indefinitely as long as there is additional input data to process.

The computational machine can also be used advantageously for many other applications, with variations (often minor) from what is described above. For example, it can potentially be used for any other wave-based object detection/ranging technique, such as LIDAR or sonar, and/or for medical imaging applications such as ultrasound, MRI, computerized tomography (CT), nuclear medicine tomography, and many other applications. For example, the X input signal may come from a receiver photodiode in the case of a LIDAR system, or from the output of an ultrasonic or other acoustic transducer in the case of an ultrasound or sonar system, or from an x-ray, gamma or other radio frequency (RF) detector in the cases of CT, nuclear medicine or MRI.

Unless contrary to physical possibility, it is envisioned that (i) the methods/steps described herein may be performed in any sequence and/or in any combination, and that (ii) the components of respective embodiments may be combined in any manner.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

### EXAMPLES

The following example embodiments have been described herein:

1. A computational machine comprising: a first data buffer to store a multi-bit binary input data value; a second data buffer to store a multi-bit binary weight value; a correlator neuron circuit including a plurality of single-bit digital dendrites, each of the single-bit digital dendrites coupled to input, at a point in time, one bit of the multi-bit binary input data value from the first data buffer and one bit of the multi-bit binary weight value from the second data buffer, the correlator neuron circuit being arranged to generate an output signal indicative of a correlation between the buffered multi-bit binary input data value and the buffered multi-bit binary weight value; and a controller coupled to provide the multi-bit binary weight value to the correlator neuron circuit, the controller further being arranged to control one or both of the first data buffer and the second data buffer to cause a shifting, relative to each other, of the multi-bit binary input data value and the multi-bit binary weight value.

2. The computational machine of example 1, wherein the correlator neuron circuit is further arranged to generate a plurality of summation signals based on outputs of the plurality of single-bit digital dendrites, and to generate the output signal based on a comparison of the plurality of summation signals.

3. The computational machine of example 1 or example 2, wherein each of the plurality of summation signals is an analog summation signal.

4. The computational machine of any of examples 1 through 3, wherein the correlator neuron circuit further is coupled to receive a multi-bit binary threshold from the controller and is arranged to generate the plurality of summation signals based also on the multi-bit binary threshold.

5. The computational machine of any of examples 1 through 4, wherein the first data buffer comprises a first shift register.

6. The computational machine of any of examples 1 through 5, wherein the second data buffer comprises a second shift register.

7. The computational machine of any of examples 1 through 6, wherein the controller is further coupled to receive the output signal from the correlator neuron circuit and to provide data indicative of the output signal to a computational engine for processing.

8. The computational machine of any of examples 1 through 7, wherein the controller is further coupled to receive a result from the computational engine and to cause the result to be provided to a user device for providing output data to a user.

9. A computational machine comprising: a correlator neuron including a plurality of single-bit digital dendrites, including a plurality of single-bit data inputs that collectively form consecutive bits of a multi-bit binary input data value, each single-bit data input coupled to a first input of a separate one of the plurality of single-bit digital dendrites; and a plurality of single-bit weight inputs that collectively form consecutive bits of a multi-bit binary weight value, each single-bit weight input coupled to a second input of a separate one of the plurality of single-bit digital dendrites; a plurality of single-bit threshold inputs that collectively represent consecutive bits of a multi-bit binary threshold; a first summator coupled to input a first signal corresponding to a sum of outputs of the plurality of single-bit digital dendrites; a second summator coupled to input a second signal corresponding to a sum of outputs of the plurality of single-bit digital dendrites and the multi-bit binary threshold; a comparator having a first input coupled to an output of the first summator and a second input coupled to an output of the second summator, the comparator configured to generate an output signal of the correlator neuron indicative of whether the multi-bit binary input data value is greater than the multi-bit binary threshold; a first shift register including a first plurality of bit positions, each coupled to a separate one of the plurality of single-bit data inputs; a second shift register including a second plurality of bit positions, each coupled to a separate one of the plurality of single-bit weight inputs; and a controller coupled to control a shifting of contents of the first and second shift registers relative to each other, and to provide the multi-bit binary weight value and the multi-bit binary threshold to the correlator neuron based on user input, the controller further to receive the output signal of the correlator neuron and to apply the output signal of the correlator neuron to a computational engine, and to output a result from the computational engine to a user device, for use in generating output data to a user.

10. The computational machine of example 9, wherein each of the first summator and the second summator receives a multi-bit digital input from outputs of the plurality of dendrites, and outputs an analog sum value.

11. The computational machine of example 9 or example 10, wherein: the first summator comprises a first summing junction that forms an output of the first summator and a first plurality of weighted capacitors, each of the first plurality of weighted capacitors coupled between the first summing junction and an output of a separate one of the plurality of dendrites; and the second summator comprises a second summing junction that forms an output of the second summator and a second plurality of weighted capacitors, each of the second plurality of weighted capacitors coupled between the second summing junction and an output of a separate one of the plurality of dendrites.

12. The computational machine of any of examples 9 through 11, further comprising a serializer to serialize an input data set to form the multi-bit binary input data value and to output the multi-bit binary input data value serially to the first shift register.

13. The computational machine of any of examples 9 through 12, wherein the computational engine comprises at least one of a Fast Fourier Transform (FFT) or a pattern matching engine.

14. The computational machine of any of examples 9 through 13, wherein the computational engine comprises at least one of a pulse Doppler engine or a Constant False-Alarm Rate (CFAR) engine.

15. A method comprising: buffering a multi-bit binary input data value and a multi-bit binary weight value; outputting the buffered multi-bit binary input data value and the buffered multi-bit binary weight value in parallel to a correlator neuron that includes a plurality of single-bit digital dendrites, such that each of the single-bit digital dendrites receives one bit at a time of the multi-bit binary input data value and one bit at a time of the multi-bit binary weight value; generating, by the correlator neuron, an output signal indicative of a correlation between the buffered multi-bit binary input data value and the buffered multi-bit binary weight value; causing a shifting of the buffered multi-bit binary input data value and the buffered multi-bit binary weight value, relative to each other, as output to the correlator neuron circuit; and repeating said outputting and said generating after completion of said shifting.

16. The method of example 15, further comprising: providing data indicative of the output signal to a computational engine for processing.

17. The method of example 15 or example 16, further comprising: receiving a result of said processing from the computational engine; and causing the result to be provided to a user device for providing output data to a user.

18. The method of any of examples 15 through 17, further comprising: generating, by the correlator neuron, a plurality of summation signals based on outputs of the plurality of single-bit digital dendrites; and wherein said generating the output signal is based on a comparison of the plurality of summation signals.

19. The method of any of examples 15 through 18, wherein each of the plurality of summation signals is an analog summation signal.

20. The method of any of examples 15 through 19, further comprising: receiving, by the correlator neuron circuit, a multi-bit binary threshold; wherein said generating the plurality of summation signals is based also on the multi-bit binary threshold.

21. A computational machine comprising: a correlator neuron that includes a plurality of single-bit digital dendrites; means for buffering a multi-bit binary input data value and a multi-bit binary weight value; means for outputting the buffered multi-bit binary input data value and the buffered multi-bit binary weight value in parallel to the correlator neuron that such that each of the single-bit digital dendrites receives one bit at a time of the multi-bit binary input data value and one bit at a time of the multi-bit binary weight value; means for generating, by the correlator neuron, an output signal indicative of a correlation between the buffered multi-bit binary input data value and the buffered multi-bit binary weight value; means for causing a shifting of the buffered multi-bit binary input data value and the buffered multi-bit binary weight value, relative to each other, as output to the correlator neuron circuit; and means for repeating said outputting and said generating after completion of said shifting.

22. The computational machine of example 21, further comprising: means for providing data indicative of the output signal to a computational engine for processing.

23. The computational machine of example 21 or example 22, further comprising: means for receiving a result of said processing from the computational engine; and means for causing the result to be provided to a user device for providing output data to a user.

24. The computational machine of any of examples 21 through 23, further comprising: means for generating, by the correlator neuron, a plurality of summation signals based on outputs of the plurality of single-bit digital dendrites; and wherein said generating the output signal is based on a comparison of the plurality of summation signals.

25. The method of any of examples 21 through 24, wherein each of the plurality of summation signals is an analog summation signal.

26. The method of any of examples 21 through 25, further comprising: receiving, by the correlator neuron circuit, a multi-bit binary threshold; wherein said generating the plurality of summation signals is based also on the multi-bit binary threshold.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A computational machine comprising:
a transmit antenna to transmit a first wireless signal corresponding to a multi-bit binary weight value;
a receive antenna to receive a second wireless signal;
a first mixer having a first input coupled to the receive antenna and having a second input coupled to a first local oscillator signal;
a second mixer having an output coupled to the transmit antenna, the second mixer further having a first input coupled to a second local oscillator signal;
a first data buffer coupled directly to an output of the first mixer, to capture values of the output of the first mixer as a multi-bit binary input data value corresponding to the second wireless signal;
a second data buffer to store the multi-bit binary weight value;
a correlator neuron circuit including a plurality of single-bit digital dendrites, each of the single-bit digital dendrites coupled to input, at a point in time, one bit of the multi-bit binary input data value from the first data buffer and one bit of the multi-bit binary weight value from the second data buffer, the correlator neuron circuit being arranged to generate an output signal indicative of a correlation between the buffered multi-bit binary input data value and the buffered multi-bit binary weight value; and
a controller coupled to provide the multi-bit binary weight value to the correlator neuron circuit and to a second input of the second mixer, the controller further being arranged to control one or both of the first data buffer and the second data buffer to cause a shifting, relative to each other, of the multi-bit binary input data value and the multi-bit binary weight value.

2. The computational machine of claim 1, wherein the correlator neuron circuit is further arranged to generate a plurality of summation signals based on outputs of the plurality of single-bit digital dendrites, and to generate the output signal based on a comparison of the plurality of summation signals.

3. The computational machine of claim 2, wherein each of the plurality of summation signals is an analog summation signal.

4. The computational machine of claim 2, wherein the correlator neuron circuit further is coupled to receive a multi-bit binary threshold from the controller and is arranged to generate the plurality of summation signals based also on the multi-bit binary threshold.

5. The computational machine of claim 1, wherein the first data buffer comprises a first shift register.

6. The computational machine of claim 5, wherein the second data buffer comprises a second shift register.

7. The computational machine of claim 1, wherein the controller is further coupled to receive the output signal from the correlator neuron circuit and to provide data indicative of the output signal to a computational engine for processing.

8. The computational machine of claim 7, wherein the controller is further coupled to receive a result from the computational engine and to cause the result to be provided to a user device for providing output data to a user.

9-12. (canceled)

13. The computational machine of claim 1, further comprising at least one of a Fast Fourier Transform (FFT) engine or a pattern matching engine.

14. The computational machine of claim 1, further comprising at least one of a pulse Doppler engine or a Constant False-Alarm Rate (CFAR) engine.

15-20. (canceled)

21. A computational machine comprising:
a transmit antenna to transmit a first wireless signal corresponding to a multi-bit binary weight value;
a receive antenna to receive a second wireless signal;
a first mixer having a first input coupled to the receive antenna and having a second input coupled to a local oscillator signal;
a first data buffer coupled directly to an output of the first mixer, to capture values of the output of the first mixer as a multi-bit binary input data value;
a second data buffer to store the multi-bit binary weight value;
a multi-tap digital phase comparison circuit including a plurality of digital taps, each tap of the plurality of digital taps being coupled to input, at a point in time, one bit of the multi-bit binary input data value from the first data buffer and one bit of the multi-bit binary weight value from the second data buffer, wherein when in operation, an output of the multi-tap digital phase comparison circuit is indicative of a correlation between the first wireless signal and the second wireless signal; and
a controller coupled to provide the multi-bit binary weight value to the multi-tap digital phase comparison circuit, the controller further being arranged to control one or both of the first data buffer and the second data buffer to cause a shifting, relative to each other, of the multi-bit binary input data value and the multi-bit binary weight value.

22. The computational machine of claim 21, wherein the multi-tap digital phase comparison circuit comprises a correlator neuron circuit including a plurality of single-bit digital dendrites, each of the single-bit digital dendrites coupled to input, at a point in time, one bit of the multi-bit binary input data value from the first data buffer and one bit of the multi-bit binary weight value from the second data buffer, the correlator neuron circuit being arranged to generate an output signal indicative of a correlation between the buffered multi-bit binary input data value and the buffered multi-bit binary weight value.

23. The computational machine of claim 21, further comprising a second mixer;
wherein the controller is further coupled to provide the multi-bit binary weight value to a first input of the second mixer.

24. The computational machine of claim 22, wherein a second input of the second mixer is coupled to a second local oscillator signal.

25. A computational machine comprising:
a programmable logic circuit device including
data input interface,
a data parser and serializer to receive an input data stream from the data input interface and to output a parsed and serialized data stream, and
a controller to output a multi-bit binary weight value, and
a host interface through which to output a correlation result to a host device;
a first data buffer coupled to an output of the data parser and serializer, to capture values of the parsed and serialized data stream as a multi-bit binary input data value corresponding to the input data stream;
a second data buffer to store the multi-bit binary weight value; and
a correlator neuron circuit including a plurality of single-bit digital dendrites, each of the single-bit digital dendrites coupled to input, at a point in time, one bit of the multi-bit binary input data value from the first data buffer and one bit of the multi-bit binary weight value from the second data buffer, the correlator neuron circuit being arranged to generate and output to the controller an output signal indicative of a correlation between the input data stream and the multi-bit binary weight value;
the controller further being arranged to control one or both of the first data buffer and the second data buffer to cause a shifting, relative to each other, of the multi-bit binary input data value and the multi-bit binary weight value.

26. The computational machine of claim 25, wherein the correlator neuron circuit is further arranged to generate a plurality of analog summation signals based on outputs of the plurality of single-bit digital dendrites, and to generate the output signal based on a comparison of the plurality of analog summation signals.

27. The computational machine of claim 26, wherein:
the correlator neuron circuit further is coupled to receive a multi-bit binary threshold from the controller and is arranged to generate the plurality of summation signals based also on the multi-bit binary threshold;
the first data buffer comprises a first shift register and the second data buffer comprises a second shift register.

28. The computational machine of claim 27, wherein the controller is further coupled to receive the output signal from the correlator neuron circuit and to provide data indicative of the output signal to a computational engine for processing.
